(19) United States
(12) Patent Application Publication
(10) Pub. No.: US 2024/0419060 A1
(43) Pub. Date: Dec. 19, 2024

(54) OPTICAL MACHINE MODULE AND PROJECTOR DEVICE

(71) Applicant: Qisda Corporation, Taoyuan City (TW)

(72) Inventors: Ko-Szu Yu, Taoyuan City (TW); Wei-Chun Peng, Taoyuan City (TW); Chieh-Ming Hsieh, Taoyuan City (TW); Yi-Ling Lo, Taoyuan City (TW)

(73) Assignee: Qisda Corporation, Taoyuan City (TW)

(21) Appl. No.: 18/739,281

(22) Filed: Jun. 10, 2024

(30) Foreign Application Priority Data
Jun. 14, 2023 (CN) 202310704763.3

(51) Int. Cl. G03B 21/14; G03B 21/20

(52) U.S. Cl. CPC G03B 21/145; G03B 21/2066; G03B 21/208

(57) ABSTRACT

An optical machine module includes an optical machine housing and at least one reflector adjustment mechanism. The reflector adjustment mechanism includes an adjustment base movably disposed in the optical machine housing, at least one reflector disposed on the adjustment base, a fulcrum adjustment member including a fulcrum adjustment part located outside the optical machine housing and a fulcrum connection part extending into the optical machine housing and adjustably connected to a center of the adjustment base, a first axial adjustment member including a first axial adjustment part and a first connection part, and a second axial adjustment member including a second axial adjustment part and a second connection part. The first and second axial adjustment parts are located outside the optical machine housing. The first and second connection parts extend into the optical machine housing and are adjustably connected to the adjustment base.

### CROSS-REFERENCE TO RELATED APPLICATION

This application claims the priority benefit of China application serial no. 202310704763.3, filed on Jun. 14, 2023. The entirety of the above-mentioned patent application is hereby incorporated by reference herein and made a part of this specification.

### BACKGROUND

### Technical Field

The disclosure relates to an optical machine module and a projector device, and in particular, to an optical machine module and a projector device having a reflector adjustment mechanism.

### Description of Related Art

The optical path design in the projector is composed of a plurality of optical elements. Each optical element is fixed through a corresponding mechanical component. Since each optical element and the corresponding mechanical component have tolerances, there will be cumulative tolerances generated when the optical system is assembled, thereby causing optical path deviation and affecting optical performance. It is the goal of research in this field to solve the problem of cumulative tolerance and return the optical path to the correct position.

### SUMMARY

The disclosure provides an optical machine module, which has a reflector adjustment mechanism, and an angle of a reflector can be adjusted to obtain a required optical path.

The disclosure provides a projector device, which has the optical machine module.

An optical machine module of the disclosure includes an optical machine housing and at least one reflector adjustment mechanism. Each reflector adjustment mechanism includes at least one reflector, an adjustment base, a fulcrum adjustment member, a first axial adjustment member, and a second axial adjustment member. The at least one reflector is located in the optical machine housing. The adjustment base is movably disposed in the optical machine housing. The at least one reflector is disposed on the adjustment base. The fulcrum adjustment member includes a fulcrum adjustment part and a fulcrum connection part. The fulcrum adjustment part is located outside the optical machine housing, and the fulcrum connection part extends into the optical machine housing and is adjustably connected to a center of the adjustment base to adjust a position of the adjustment base relative to the optical machine housing. The first axial adjustment member includes a first axial adjustment part and a first connection part. The first axial adjustment part is located outside the optical machine housing. The first connection part extends into the optical machine housing and is adjustably connected to the adjustment base to adjust an angle of the adjustment base in a first axial direction. The second axial adjustment member includes a second axial adjustment part and a second connection part. The second axial adjustment part is located outside the optical machine housing. The second connection part extends into the optical machine housing and is adjustably connected to the adjustment base to adjust the angle of the adjustment base in a second axial direction.

In an embodiment of the disclosure, a line connecting the first axial adjustment member and the fulcrum adjustment member is orthogonal to a line connecting the second axial adjustment member and the fulcrum adjustment member.

In an embodiment of the disclosure, the optical machine housing includes a first positioning part. The adjustment base includes a second positioning part corresponding to the first positioning part. The adjustment base is positioned on the optical machine housing through the cooperation of the second positioning part and the first positioning part.

In an embodiment of the disclosure, the first positioning part includes a hemispherical recess, and the second positioning part includes a hemispherical surface located in the hemispherical recess.

In an embodiment of the disclosure, each reflector adjustment mechanism further includes a first elastic member. The first elastic member is located outside the optical machine housing and abuts between the fulcrum adjustment member and the optical machine housing. Alternatively, the first elastic member is located in the optical machine housing and abuts between the adjustment base and the optical machine housing.

In an embodiment of the disclosure, each reflector adjustment mechanism further includes a second elastic member located in the optical machine housing, surrounding the first connection part, and abutting between the adjustment base and the optical machine housing.

In an embodiment of the disclosure, each reflector adjustment mechanism further includes a third elastic member located in the optical machine housing, surrounding the second connection part, and abutting between the adjustment base and the optical machine housing.

In an embodiment of the disclosure, at least one reflector of the reflector adjustment mechanism includes a plurality of reflectors, and the reflectors are disposed on the adjustment base.

In an embodiment of the disclosure, the adjustment base includes a plurality of regions with steps, and the reflectors are respectively disposed in the regions.

In an embodiment of the disclosure, the at least one reflector adjustment mechanism includes a plurality of independent reflector adjustment mechanisms.

A projector device of the disclosure includes the optical machine module, an imaging module, and a lens module. The optical machine module is configured to provide an illumination beam. The imaging module is located on an optical path of the illumination beam to convert the illumination beam into an image beam. The lens module is located on an optical path of the image beam to project the image beam out of the projector device.

Based on the above, the adjustment base of the reflector adjustment mechanism of the optical machine module of the disclosure is movably disposed in the optical machine housing, and the reflector is disposed on the adjustment base. The fulcrum adjustment part of the fulcrum adjustment member of the reflector adjustment mechanism is located outside the optical machine housing. The fulcrum connection part of the fulcrum adjustment member extends into the optical machine housing and is adjustably connected to the center of the adjustment base to adjust the position of the adjustment base relative to the optical machine housing. The first axial adjustment part of the first axial adjustment member is located outside the optical machine housing. The first connection part extends into the optical machine housing and is adjustably connected to the adjustment base to adjust the angle of the adjustment base in the first axial direction. The second axial adjustment part of the second axial adjustment member is located outside the optical machine housing. The second connection part extends into the optical machine housing and is adjustably connected to the adjustment base to adjust the angle of the adjustment base in the second axial direction.

Therefore, the optical machine module of the disclosure can adjust the position of the adjustment base and the angles of the adjustment base in the first and second axial directions by adjusting the fulcrum adjustment part and the first and second axial adjustment parts located outside the optical machine housing, so that the position and the angle of the reflector on the adjustment base can be changed to provide the required optical path. Furthermore, since the fulcrum adjustment part and the first and second axial adjustment parts are located outside the optical machine housing, the adjustment process does not require disassembly of the optical machine housing, which is very convenient and can prevent dust from entering the optical machine housing. In addition, the part of the reflector adjustment mechanism located in the optical machine housing does not require an airtight design and can effectively save costs.

### BRIEF DESCRIPTION OF THE DRAWINGS

FIG. 1 is a partial schematic cross-sectional view of an optical machine module according to an embodiment of the disclosure.

FIG. 2 is a partially enlarged schematic view of FIG. 1.

FIG. 3 is an exploded schematic view of FIG. 2.

FIG. 4 is a schematic view of FIG. 2 from another perspective.

FIG. 5 is an exploded schematic view of FIG. 4.

FIG. 6 is an exploded schematic view of FIG. 2 from another perspective.

FIG. 7 is a partial schematic perspective view of an optical machine module according to another embodiment of the disclosure.

FIG. 8 is a schematic view of a projector device according to an embodiment of the disclosure.

### DESCRIPTION OF THE EMBODIMENTS

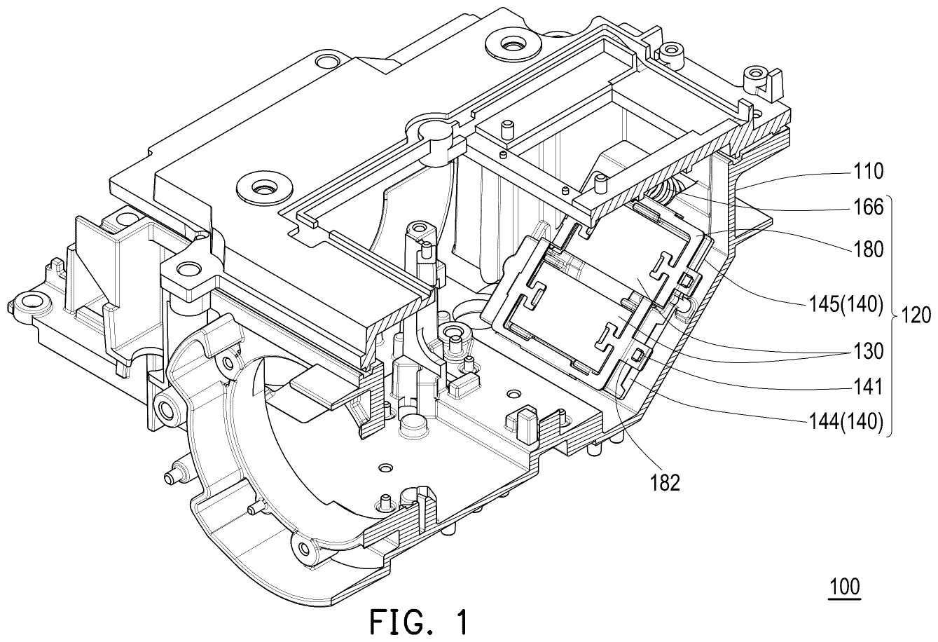

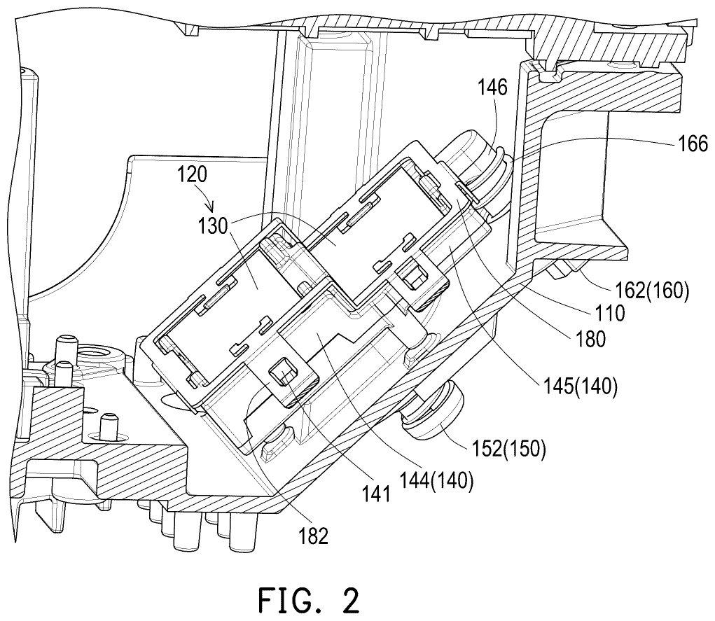

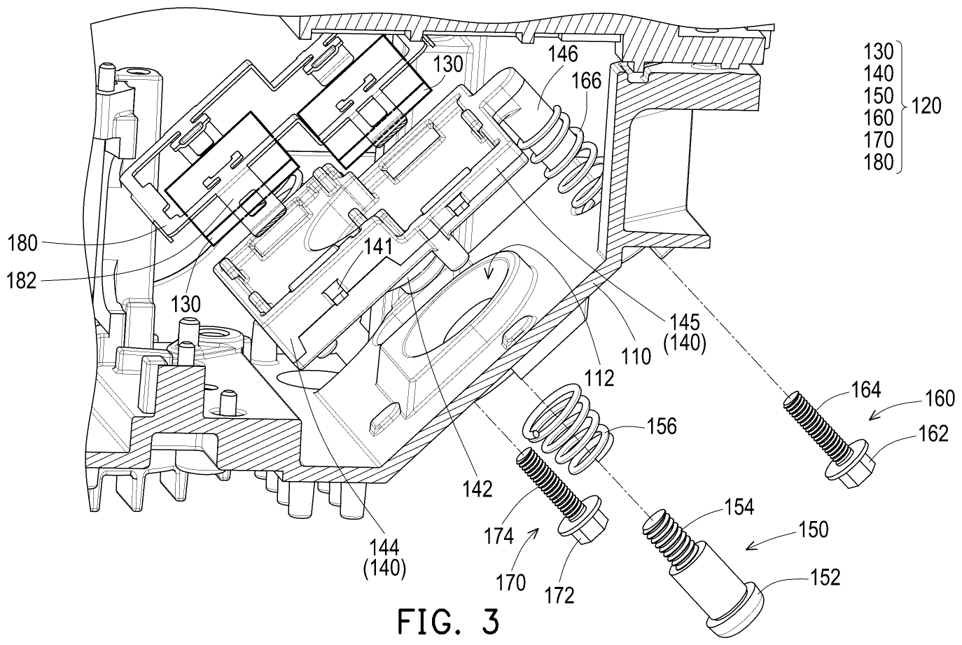

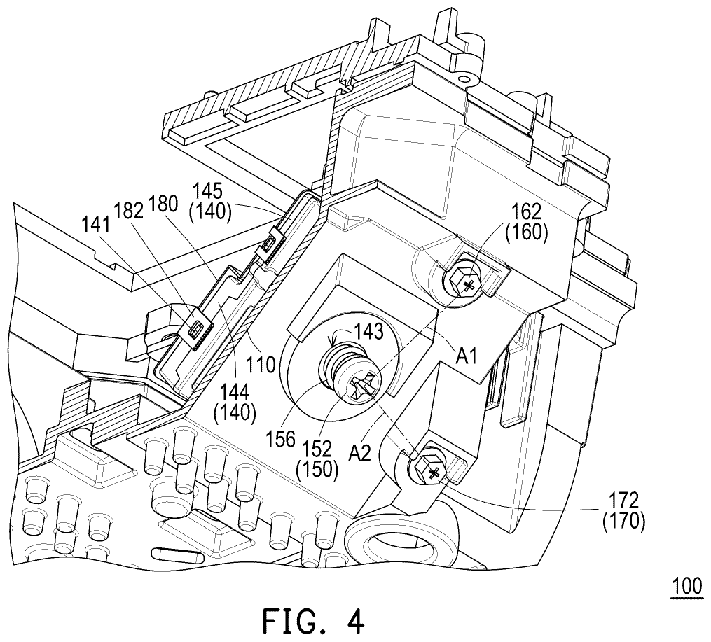

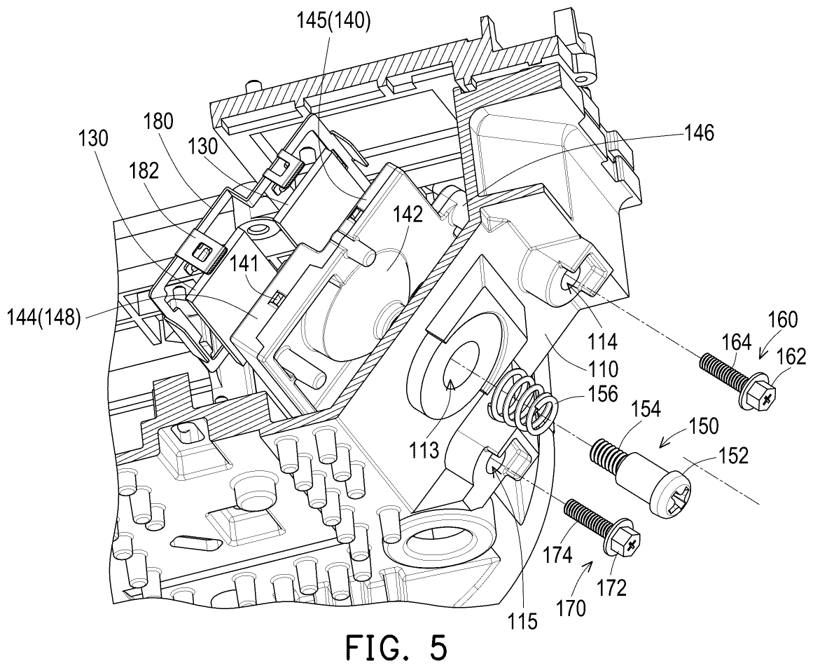

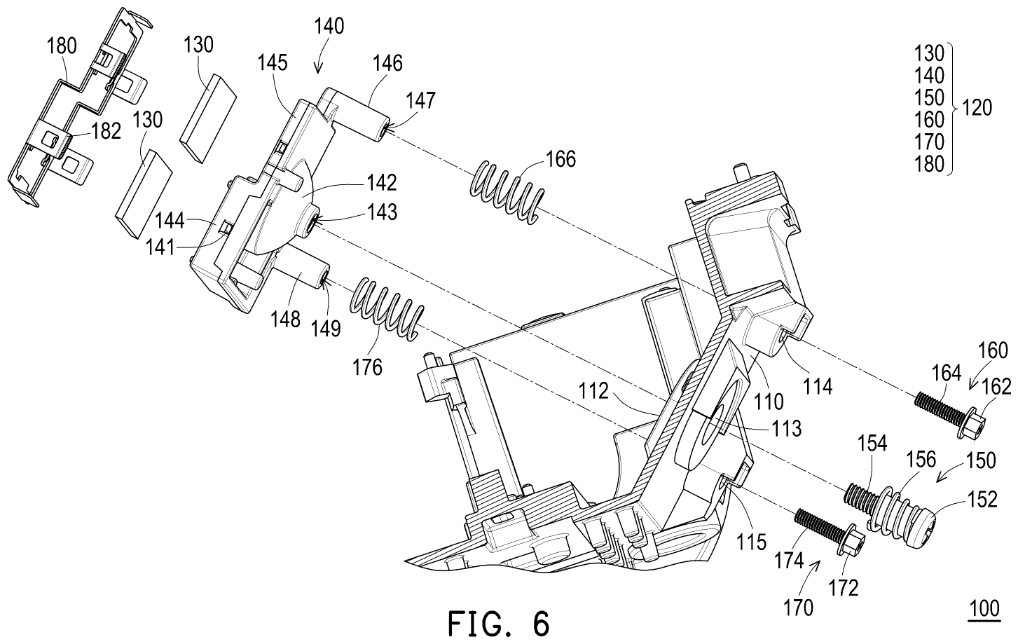

FIG. 1 is a partial schematic cross-sectional view of an optical machine module according to an embodiment of the disclosure. FIG. 2 is a partially enlarged schematic view of FIG. 1. FIG. 3 is an exploded schematic view of FIG. 2. FIG. 4 is a schematic view of FIG. 2 from another perspective. FIG. 5 is an exploded schematic view of FIG. 4. FIG. 6 is an exploded schematic view of FIG. 2 from another perspective. It should be noted that in order to clearly show the detailed structure of the reflector adjustment mechanism, other components in the optical machine housing are hidden.

Referring to FIG. 1 to FIG. 6, an optical machine module 100 of the embodiment includes an optical machine housing 110 and at least one reflector adjustment mechanism 120. In the embodiment, the number of the reflector adjustment mechanism 120 is one, but is not limited thereto. As shown in FIG. 6, the reflector adjustment mechanism 120 includes at least one reflector 130, an adjustment base 140, a fulcrum adjustment member 150, a first axial adjustment member 160 and a second axial adjustment member 170.

In the embodiment, the adjustment base 140 is movably disposed in the optical machine housing 110, and the reflector 130 is located in the optical machine housing 110 to reflect light from a light source (not shown). In addition, the reflector 130 is disposed on the adjustment base 140 to change the position and the angle along with the adjustment base 140 to absorb the cumulative tolerance generated by the assembly of the mechanism. In the embodiment, the number of the reflector 130 is, for example, two, but the number of the reflector 130 is not limited thereto. For example, the adjustment base 140 includes a plurality of regions 144 and 145 with steps, and the two reflectors 130 are respectively disposed in the regions 144 and 145 on the adjustment base 140. Certainly, in other embodiments, the two reflectors 130 may also be coplanar.

The optical machine module 100 of the embodiment also includes a fixing member 180 disposed on the reflector 130. The fixing member 18 includes a plurality of buckles 182 that engage with a hook 141 of the adjustment base 140 to fix the reflector 130 to the adjustment base 140.

The optical machine housing 110 includes a first positioning part 112 (FIG. 3). The adjustment base 140 includes a second positioning part 142 (FIG. 5) corresponding to the first positioning part 112. The adjustment base 140 is positioned on the optical machine housing 110 through the cooperation of the second positioning part 142 and the first positioning part 112. In the embodiment, the first positioning part 112 includes a hemispherical recess, and the second positioning part 142 includes a hemispherical surface located in the hemispherical recess. The matching design of the hemispherical surface and the hemispherical recess allows the second positioning part 142 of the adjustment base 140 to be easily positioned into the first positioning part 112 of the optical machine housing 110 and achieve a centering effect. Certainly, in other embodiments, the shapes of the first positioning part 112 and the second positioning part 142 are not limited thereto.

As shown in FIG. 6, the fulcrum adjustment member 150 includes a fulcrum adjustment part 152 and a fulcrum connection part 154. The fulcrum adjustment part 152 is located outside the optical machine housing 110. The fulcrum connection part 154 passes through a through hole 113 to extend into the optical machine housing 110 and is adjustably connected to a hole 143 in a center of the adjustment base 140 to adjust the position of the adjustment base 140 relative to the optical machine housing 110. In the embodiment, the fulcrum connection part 154 has an external thread and is screwed to the hole 143 of the adjustment base 140. Therefore, an assembler can cause the adjustment base 140 to move closer to the first positioning part 112 of the optical machine housing 110 or further away from the first positioning part 112 by rotating the fulcrum adjustment member 150.

The reflector adjustment mechanism 120 further includes a first elastic member 156. The first elastic member 156 is located outside the optical machine housing 110 and abuts between the fulcrum adjustment member 150 and the optical machine housing 110. Specifically, the first elastic member 156 is sleeved on the fulcrum adjustment member 150 and is located between the fulcrum adjustment part 152 and an outer surface of the optical machine housing 110. The first elastic member 156 can cause the fulcrum adjustment part 152 to be pushed in a direction away from the outer surface of the optical machine housing 110, so that the adjustment base 140 can be stably disposed in the optical machine housing 110. The first elastic member 156 is, for example, a spring, but may also be other components such as rubber.

In an embodiment not shown, the first elastic member 156 can also be located in the optical machine housing 110 and abut between the adjustment base 140 and the optical machine housing 110, which can also achieve the effect in which the adjustment base 140 can be stably disposed in the optical machine housing 110.

In the embodiment, the first axial adjustment member 160 includes a first axial adjustment part 162 and a first connection part 164. The first axial adjustment member 160 is located in a first axial direction A1 (FIG. 4) relative to the fulcrum adjustment member 150. The first axial adjustment part 162 is located outside the optical machine housing 110. The first connection part 164 passes through a through hole 114 to extend into the optical machine housing 110 and is adjustably connected to the adjustment base 140. In the embodiment, the first connection part 164 has an external thread and is screwed to a screw hole 147 of a column 146 of the adjustment base 140 to adjust an angle of the adjustment base 140 in the first axial direction A1.

Therefore, the assembler can adjust the degree to which the first connection part 164 extends into the screw hole 147 of the column 146 of the adjustment base 140 by rotating the first axial adjustment part 162, so that the adjustment base 140 is deflected in the first axial direction A1 to change the angle in the first axial direction A1.

In addition, the reflector adjustment mechanism 120 further includes a second elastic member 166 located in the optical machine housing 110, surrounding the column 146 and the first connection part 164, and abutting between the adjustment base 140 and the optical machine housing 110. The second elastic member 166 can cause the adjustment base 140 to be pushed in a direction away from an inner surface of the optical machine housing 110, so that the adjustment base 140 can be stably disposed in the optical machine housing 110. The second elastic member 166 is, for example, a spring, but may also be other components such as rubber.

Furthermore, the second axial adjustment member 170 includes a second axial adjustment part 172 and a second connection part 174. The second axial adjustment member 170 is located in a second axial direction A2 (FIG. 4) relative to the fulcrum adjustment member 150. The second axial adjustment part 172 is located outside the optical machine housing 110. The second connection part 174 passes through a through hole 115 to extend into the optical machine housing 110 and is adjustably connected to the adjustment base 140. In the embodiment, the second connection part 174 has an external thread and is screwed to a screw hole 149 of a column 148 of the adjustment base 140 to adjust the angle of the adjustment base 140 in the second axial direction A2.

Therefore, the assembler can adjust the degree to which the second connection part 174 extends into the screw hole 149 of the column 148 of the adjustment base 140 by rotating the second axial adjustment part 172, so that the adjustment base 140 is deflected in the second axial direction A2 to change the angle in the second axial direction A2.

In addition, the reflector adjustment mechanism 120 further includes a third elastic member 176 located in the optical machine housing 110, surrounding the column 148 and the second connection part 174, and abutting between the adjustment base 140 and the optical machine housing 110. The third elastic member 176 can cause the adjustment base 140 to be pushed in a direction away from the inner surface of the optical machine housing 110, so that the adjustment base 140 can be stably disposed in the optical machine housing 110. The third elastic member 176 is, for example, a spring, but may also be other components such as rubber.

It is worth mentioning that, in the embodiment, since the fulcrum connection part 154 is connected to the center of the adjustment base 140, and a line connecting the first axial adjustment member 160 and the fulcrum adjustment member 150 (the first axial direction A1) is orthogonal to a line connecting the second axial adjustment member 170 and the fulcrum adjustment member 150 (the second axial direction A2). The assembler can intuitively obtain optical performance feedback during the process of adjusting the first axial adjustment part 162 and the second axial adjustment part 172, which is very convenient and saves adjustment time.

The optical machine module 100 of the embodiment can adjust the position of the adjustment base 140 and the angles of the adjustment base 140 in the first axial direction and the second axial direction A2 by adjusting the fulcrum adjustment part 152, the first axial adjustment part 162, and the second axial adjustment part 172 located outside the optical machine housing 110, so that the position and the angle of the reflector 130 on the adjustment base 140 can be changed to effectively solve the problem of cumulative tolerance and return the optical path to the correct position so as to provide the required optical path. In addition, the reflector adjustment mechanism 120 has a relatively small number of components, is simple and convenient to assemble, and has low cost.

Furthermore, since the fulcrum adjustment part 152, the first axial adjustment part 162, and the second axial adjustment part 172 are located outside the optical machine housing 110, the adjustment process does not require disassembly of the optical machine housing 110, which is quite convenient and prevent dust from entering the optical machine housing 110. In addition, the part of the reflector adjustment mechanism 120 located in the optical machine housing 110 does not require an airtight design and can effectively save costs.

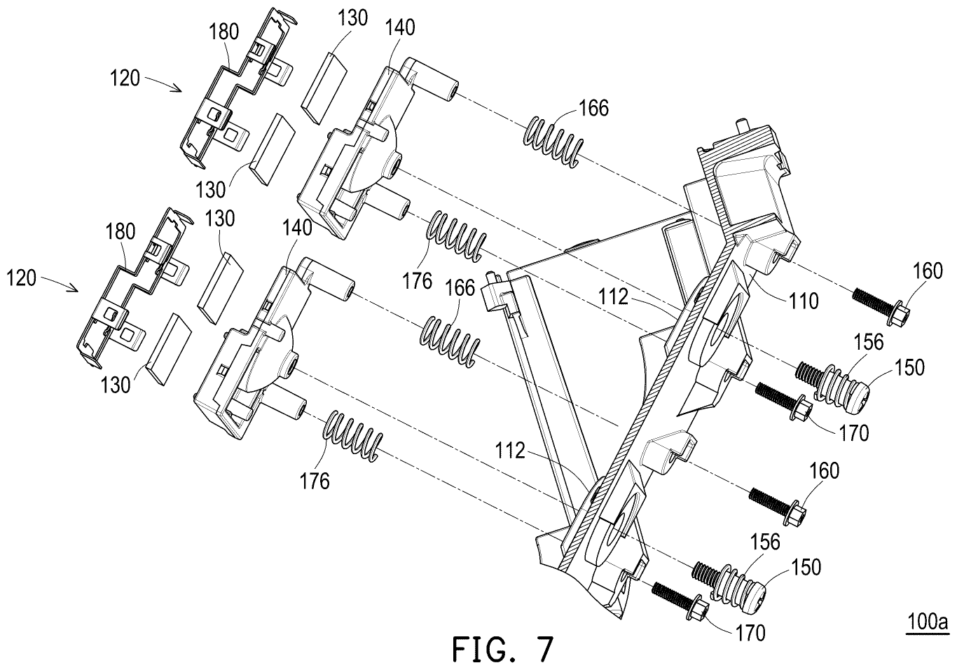

FIG. 7 is a partial schematic perspective view of an optical machine module according to another embodiment of the disclosure. Please refer to FIG. 7. The main difference between an optical machine module 100a of the embodiment and the optical machine module 100 of the previous embodiment is that in the embodiment, the optical machine module 100a includes a plurality of independent reflector adjustment mechanisms 120. FIG. 7 takes two reflector adjustment mechanisms 120 as an example, but the number of the reflector adjustment mechanisms 120 is not limited thereto. In the embodiment, the two reflector adjustment mechanisms 120 can be adjusted independently to provide a more precise optical path.

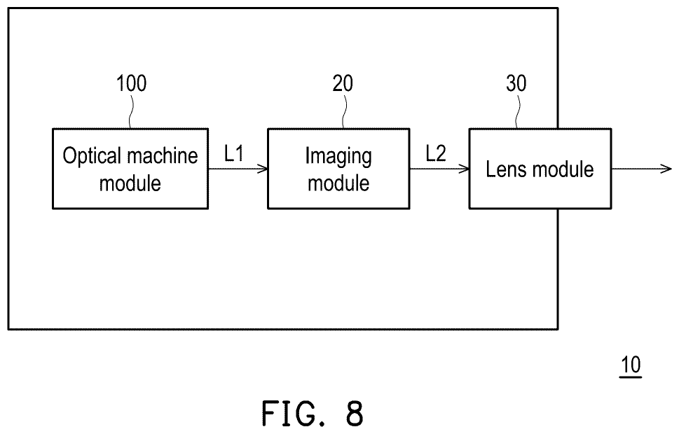

FIG. 8 is a schematic view of a projector device according to an embodiment of the disclosure. Please refer to FIG. 8. A projector device 10 of the embodiment includes an optical machine module 100, an imaging module 20, and a lens module 30. The optical machine module 100 is, for example, the optical machine module 100 of FIG. 1. In other embodiments, it can also be the optical machine module 100a of FIG. 7, and the reflector adjustment mechanism 120 can be used to adjust the position and the angle of the reflector 130 so as to provide the required optical path, but the types of the optical machine module 100 and 100a are not limited to FIG. 1 or FIG. 7.

The optical machine module 100 is configured to provide an illumination beam L1. The illumination beam L1 leaves the optical machine module 100 along the required optical path. The imaging module 20 is located on the optical path of the illumination beam L1 to convert the illumination beam L1 into an image beam L2. The imaging module 20 is, for example, a digital micromirror device (DMD), but the type of the imaging module 20 is not limited thereto. The lens module 30 is located on an optical path of the image beam L2 to project the image beam L2 out of the projector device 10.

To sum up, the adjustment base of the reflector adjustment mechanism of the optical machine module of the disclosure is movably disposed in the optical machine housing, and the reflector is disposed on the adjustment base. The fulcrum adjustment part of the fulcrum adjustment member of the reflector adjustment mechanism is located outside the optical machine housing. The fulcrum connection part of the fulcrum adjustment member extends into the optical machine housing and is adjustably connected to the center of the adjustment base to adjust the position of the adjustment base relative to the optical machine housing. The first axial adjustment part of the first axial adjustment member is located outside the optical machine housing, and the first connection part extends into the optical machine housing and is adjustably connected to the adjustment base to adjust the angle of the adjustment base in the first axial direction. The second axial adjustment part of the second axial adjustment member is located outside the optical machine housing, and the second connection part extends into the optical machine housing and is adjustably connected to the adjustment base to adjust the angle of the adjustment base in the second axial direction.

Therefore, the optical machine module of the disclosure can adjust the position of the adjustment base and the angles of the adjustment base in the first and second axial directions by adjusting the fulcrum adjustment part and the first and second axial adjustment parts located outside the optical machine housing, so that the position and the angle of the reflector on the adjustment base can be changed to provide the required optical path. Furthermore, since the fulcrum adjustment part and the first and second axial adjustment parts are located outside the optical machine housing, the adjustment process does not require disassembly of the optical machine housing, which is very convenient and can prevent dust from entering the optical machine housing. In addition, the part of the reflector adjustment mechanism located in the optical machine housing does not require an airtight design and can effectively save costs.

What is claimed is:

1. An optical machine module, comprising:
an optical machine housing; and
at least one reflector adjustment mechanism, wherein each reflector adjustment mechanism comprises:
at least one reflector, located in the optical machine housing;
an adjustment base, movably disposed in the optical machine housing, wherein the at least one reflector is disposed on the adjustment base;
a fulcrum adjustment member, comprising a fulcrum adjustment part and a fulcrum connection part, wherein the fulcrum adjustment part is located outside the optical machine housing, and the fulcrum connection part extends into the optical machine housing and is adjustably connected to a center of the adjustment base to adjust a position of the adjustment base relative to the optical machine housing;
a first axial adjustment member, comprising a first axial adjustment part and a first connection part, wherein the first axial adjustment part is located outside the optical machine housing, and the first connection part extends into the optical machine housing and is adjustably connected to the adjustment base to adjust an angle of the adjustment base in a first axial direction; and
a second axial adjustment member, comprising a second axial adjustment part and a second connection part, wherein the second axial adjustment part is located outside the optical machine housing, and the second connection part extends into the optical machine housing and is adjustably connected to the adjustment base to adjust the angle of the adjustment base in a second axial direction.

2. The optical machine module according to claim 1, wherein a line connecting the first axial adjustment member and the fulcrum adjustment member is orthogonal to a line connecting the second axial adjustment member and the fulcrum adjustment member.

3. The optical machine module according to claim 1, wherein the optical machine housing comprises a first positioning part, the adjustment base comprises a second positioning part corresponding to the first positioning part, and the adjustment base is positioned on the optical machine housing through a cooperation of the second positioning part and the first positioning part.

4. The optical machine module according to claim 3, wherein the first positioning part comprises a hemispherical recess, and the second positioning part comprises a hemispherical surface located in the hemispherical recess.

5. The optical machine module according to claim 1, wherein each reflector adjustment mechanism further comprises a first elastic member, the first elastic member is located outside the optical machine housing and abuts between the fulcrum adjustment member and the optical machine housing, or the first elastic member is located in the optical machine housing and abuts between the adjustment base and the optical machine housing.

6. The optical machine module according to claim 1, wherein each reflector adjustment mechanism further comprises a second elastic member located in the optical machine housing, surrounding the first connection part, and abutting between the adjustment base and the optical machine housing.

7. The optical machine module according to claim 1, wherein each reflector adjustment mechanism further comprises a third elastic member located in the optical machine housing, surrounding the second connection part, and abutting between the adjustment base and the optical machine housing.

8. The optical machine module according to claim 1, wherein the at least one reflector of the reflector adjustment mechanism comprises a plurality of reflectors, and the reflectors are disposed on the adjustment base.

9. The optical machine module according to claim 8, wherein the adjustment base comprises a plurality of regions with steps, and the reflectors are respectively disposed in the regions.

10. The optical machine module according to claim 1, wherein the at least one reflector adjustment mechanism comprises a plurality of independent reflector adjustment mechanisms.

11. A projector device, comprising:
the optical machine module according to claim 1, configured to provide an illumination beam;
an imaging module, located on an optical path of the illumination beam to convert the illumination beam into an image beam; and
a lens module, located on an optical path of the image beam to project the image beam out of the projector device.

12. A projector device, comprising:
the optical machine module according to claim 2, configured to provide an illumination beam;
an imaging module, located on an optical path of the illumination beam to convert the illumination beam into an image beam; and
a lens module, located on an optical path of the image beam to project the image beam out of the projector device.

13. A projector device, comprising:
the optical machine module according to claim 3, configured to provide an illumination beam;
an imaging module, located on an optical path of the illumination beam to convert the illumination beam into an image beam; and
a lens module, located on an optical path of the image beam to project the image beam out of the projector device.

14. A projector device, comprising:
the optical machine module according to claim 4, configured to provide an illumination beam;
an imaging module, located on an optical path of the illumination beam to convert the illumination beam into an image beam; and
a lens module, located on an optical path of the image beam to project the image beam out of the projector device.

15. A projector device, comprising:
the optical machine module according to claim 5, configured to provide an illumination beam;
an imaging module, located on an optical path of the illumination beam to convert the illumination beam into an image beam; and
a lens module, located on an optical path of the image beam to project the image beam out of the projector device.

16. A projector device, comprising:
the optical machine module according to claim 6, configured to provide an illumination beam;
an imaging module, located on an optical path of the illumination beam to convert the illumination beam into an image beam; and
a lens module, located on an optical path of the image beam to project the image beam out of the projector device.

17. A projector device, comprising:
the optical machine module according to claim 7, configured to provide an illumination beam;
an imaging module, located on an optical path of the illumination beam to convert the illumination beam into an image beam; and
a lens module, located on an optical path of the image beam to project the image beam out of the projector device.

18. A projector device, comprising:
the optical machine module according to claim 8, configured to provide an illumination beam;
an imaging module, located on an optical path of the illumination beam to convert the illumination beam into an image beam; and
a lens module, located on an optical path of the image beam to project the image beam out of the projector device.

19. A projector device, comprising:
the optical machine module according to claim 9, configured to provide an illumination beam;
an imaging module, located on an optical path of the illumination beam to convert the illumination beam into an image beam; and
a lens module, located on an optical path of the image beam to project the image beam out of the projector device.

20. A projector device, comprising:
the optical machine module according to claim 10, configured to provide an illumination beam;
an imaging module, located on an optical path of the illumination beam to convert the illumination beam into an image beam; and
a lens module, located on an optical path of the image beam to project the image beam out of the projector device.
